(19) United States
(12) Patent Application Publication
(10) Pub. No.: US 2025/0276370 A1
(43) Pub. Date: Sep. 4, 2025

(54) Method and Device for Generating Irradiation Control Data for a Device for Additive Manufacturing of a Component

(71) Applicant: EOS GMBH ELECTRO OPTICAL SYSTEMS, Krailling (DE)

(72) Inventor: Ludger Hümmeler, Gauting (DE)

(21) Appl. No.: 18/862,510

(22) PCT Filed: Apr. 27, 2023
(86) PCT No.: PCT/EP2023/061191

§ 371 Date: Nov. 1, 2024

(51) Int. Cl. B22F 10/366; B22F 10/85; B33Y 10/00; B33Y 30/00; B33Y 50/02

(52) U.S. Cl. CPC B22F 10/366; B22F 10/85; B33Y 10/00; B33Y 30/00; B33Y 50/02

(57) ABSTRACT

Disclosed is a method for generating irradiation control data for an additive manufacturing device. The method includes providing a component dataset includes geometry data of at least one component layer of the component and/or including a trajectory dataset with scan trajectory-segments for producing a component layer of the component, creating a number of normalized intended trajectories from the component dataset. A normalized intended trajectory is formed from norm-trajectory-segments whose spatial length is an integer multiple of a norm-length which is determined from a pre-defined scan control clock of the device, generating irradiation control data such that the device can create a component layer with a solidification of building material along the number of normalized intended trajectories, and outputting the irradiation control data for the additive manufacturing of a component.

The invention relates to a method and a device (“device for generating control data”) for generating irradiation control data for a device for additive manufacturing of a component in a manufacturing process in which the component is constructed in layers in construction field by selective solidification of the building material by irradiation of the building material using at least one energy beam. The invention further relates to corresponding control data, a method for additive manufacturing of a component with such control data, a device for additive manufacturing and a control device for such a device.

Additive manufacturing processes are becoming more and more relevant in the production of prototypes and now also in series manufacture. In general, “additive manufacturing processes” are to be understood as those manufacturing processes in which a manufacturing product (“component”) is usually built up on the basis of digital 3D construction data through the deposition of material (the “building material”). The construction usually but not necessarily takes place in layers. The term “3D printing” is frequently used as a synonym for additive manufacturing, the production of models, patterns and prototypes using additive manufacturing processes is frequently designated as “rapid prototyping”, the production of tools as “rapid tooling” and the flexible production of series components is designated as “rapid manufacturing”. As mentioned initially, a central point is the selective solidification of the building material, wherein in many manufacturing processes this solidification can take place with the aid of an exposure to radiation energy, e.g. electromagnetic radiation, in particular light and/or thermal radiation but optionally using particle radiation such as electron radiation. Examples for methods operating with irradiation are “selective laser sintering” or “selective laser fusion”. In this case, thin layers of a usually powdery building material are repeatedly applied one above the other and in each layer the building material is selectively solidified in a “welding process” by spatially delimited irradiation of the locations which should pertain to the component to be manufactured after fabrication in a “welding process”, whereby the powder grains of the building material are partially or completely fused with the aid of energy introduced locally by the radiation at this location. During a cooling, these powder grains are then solidified together to form a solid. Usually in this case, the energy beam is guided along solidification tracks across the construction field and the melting or solidification of the material in the respective layer accordingly takes place in the form of “welding tracks” or “welding beads” so that ultimately a plurality of such layers formed from welding tracks is present in the component.

In practical applications or in manufacturing devices, energy beams are usually used, for example laser beams, which have substantially rotationally symmetric intensity distributions. Such a rotationally symmetric intensity distribution frequently corresponds to a Gaussian profile. In a Gaussian intensity distribution, the intensity is highest in the centre of the energy beam and weakens in all directions radially outwards perpendicular to the direction of propagation (also called “beam direction” or “beam axis” for short) according to a Gaussian function or Gaussian curve.

The energy beam is guided over the construction field according to irradiation control data. As a rule, both the movement of the energy beam and its intensity are specified by the irradiation control data. In a simple case, the control signal for the intensity can only indicate when the energy beam is switched on and when it is switched off, but there can also be performed an intensity regulation or the energy beam can be operated in a pulsed mode. The control data are usually determined directly from the geometric data of a component or its component layer, in particular by triangulation. In this case, scan vectors are determined along which the energy beam is to be moved, whereby very frequently a large number of scan vectors describe a trajectory (“intended trajectory”). Starting from the intended trajectory, this is usually a polygon course composed of individual trajectory-segments, the scan vectors. However, the problem often arises that the trajectory segments are too short, which leads to undesirable results, especially in pulsed operation.

For example, the triangulation of components with highly structured surfaces leads to strongly kinked intended trajectories with correspondingly short distances between the kinks. However, since control devices work with a fixedly pre-defined control clock, e.g. at 100 kHz (i.e. steps of 10 us each), this leads to a situation where, for distances that the energy beam passes through in a shorter time, either a waiting time must be introduced, which causes the activated energy beam to remain in one place for a correspondingly long time, or the speed must be reduced, which leads to a longer exposure time and thus to a higher energy input. This leads to localised overheating, which has a negative impact on component quality.

In practice, it is often the case that the actual scanning speed applied is automatically adjusted to the length of the scan vector within a control clock. This has the result that a lower scanning speed than actually desired predominates for short scan vectors. However, since the specifications for the power of the energy beam are based on a desired scanning speed, in this case too much energy is applied to the short scan vector during manufacture.

With a control clock of 100 kHz (period duration 10 μs), five times as much energy as desired would be applied to a scan vector whose length could be passed at the desired scanning speed in 2 μs. When triangulating a circle, it can very easily happen that all vectors of the circle are quite short, e.g. 5 μs “long”. In this case, twice the desired amount of energy would be applied to this circular intended trajectory.

It is an object of the present invention to provide a method and a device for generating control data for a device for the additive manufacturing of a component, which overcomes the disadvantages of the prior art and in particular allows an improvement in the quality of a component.

This object is achieved by a method according to claim 1, control data according to claim 10, a manufacturing method for additive manufacturing according to claim 11, a control data generation device according to claim 12, a control device according to claim 13 and a device according to claim 14.

A method according to the invention serves to generate irradiation control data for a device for the additive manufacturing of a component in a manufacturing process in which the component is constructed in layers in a construction field by selective solidification of building material by irradiation of the building material with at least one energy beam. The building material is preferably a liquid, a powder or a granulate. Preferred materials are resin, polymer, a metal-based powder with a metal content of preferably at least 50%, in particular at least 60%, 70%, 80%, 90% or even 90% or a metal powder, a ceramic or mixed materials (e.g. Alumide, a product of the applicant), materials for cold metal fusion (brand name for a combined melting/sintering process using polymer-coated metal particles as building material) or generally polymer-coated particles.

The method according to the invention comprises the following steps:
Providing a component dataset comprising geometry data of at least one component layer of the component and/or comprising a trajectory dataset with scan trajectory-segments for producing a component layer of the component,
creating a number of normalized intended trajectories from the component dataset, wherein a normalized intended trajectory is formed from norm-trajectory-segments whose spatial length is an integer multiple (i.e. N times with the positive integer N greater than zero) of a norm-length which is determined from a pre-defined scan control clock of the device,
generating irradiation control data such that the device for additive manufacturing can create a component layer with a solidification of building material along the number of normalized intended trajectories,
outputting the irradiation control data to a memory unit and/or to a device for the additive manufacturing of a component.

A component dataset is generally known to the person skilled in the art and comprises the geometric data (“geometry data”) of the component or at least one component layer of the component. This can be, for example, CAD data or data converted from CAD data.

However, a component can also be defined by pre-determined control data. The control data that is initially relevant here are the data on target trajectories (“trajectory dataset”). Such a dataset comprises at least scan trajectory-segments (scan vectors) for producing a component layer of the component, but may also comprise further exposure data, e.g. information about which intensity or pulse pattern is used for irradiation.

This component dataset is provided, which means that it is received, loaded from a memory, or created from CAD data or other geometric data of the component.

The component dataset therefore already includes a pre-defined intended trajectory or there is sufficient information available with which an intended trajectory can be determined. The method according to the invention now creates a special intended trajectory or modifies a given intended trajectory. This special intended trajectory is referred to here as a “normalized intended trajectory”, which is composed of trajectory-segments, a proportion of which is (specifically) formed from norm-trajectory-segments. These norm-trajectory-segments are not arbitrary trajectory-segments (referred to here as “scan trajectory-segments”), but rather certain rules apply to the length of these trajectory-segments. How exactly an intended trajectory is created from a component dataset is state of the art and is regularly implemented in practice when converting component datasets into control commands.

Norm-trajectory-segments have a spatial length that is an integer multiple (single, double, triple, . . . , N times) of a norm-length. This norm-length is always determined from a pre-defined scan control clock of the device and, if necessary, also from other parameters, in particular the scanning speed. The term “scan control clock” corresponds in particular to the control clock of the prior art and determines at least the timing of a control of the energy beam with at least one energy beam parameter value as well as the timing of the operation of a scanner (e.g. a galvanometer scanner and/or a polygon scanner) with at least one position specification, e.g. in the form of a 2D coordinate. For example, if the scanning speed v is given for the region of an intended trajectory, the norm-length N=vt is obtained from the scan control clock with the period t. Since the invention relates to the generation of control data, the “scanning speed” used here is a theoretical speed as intended to be used in subsequent manufacturing and not a real scanning speed in manufacturing. In order to emphasize this, it is referred to hereinafter as the “target scanning speed”. It may well be different from the “manufacturing scanning speed,” i.e. the speed at which manufacturing takes place. However, the manufacturing scanning speed is influenced by the control data. With the method according to the invention, the manufacturing scanning speed can be significantly optimized based on a target scanning speed.

In practice, the scan control clock can actually depend on several components, such as: control unit, beam guidance and other electronic and mechanical components. After all, the action specified for this period must also be carried out within a clock pulse. For a better understanding, however, it can be assumed that the control unit alone pre-defines the clock pulse and that the manufacturing device completes all the actions on time. In practice, the 20 scan control clock is frequently a fixedly pre-defined parameter of the control unit. In this case, the scan control clock is a pre-defined clock, in whose time intervals control information is transferred and processed. This takes place, for example, in such a way that in each time interval a point and a radiation power are pre-defined and the pre-defined point is approached whilst irradiation is carried out with the pre-defined radiation power. Trajectories to more distant points are therefore less strongly irradiated than trajectories to closer points, since the beam has to move faster to reach the pre-defined end point. The method according to the invention solves this problem by adapting the distances between the points to the pre-defined scan control clock.

It should be noted that in the case where the length of norm-trajectory-segments is n times the norm-length, the corresponding norm-trajectory-segments are also scanned within n scan control clocks. For example, a norm-trajectory-segment with the norm-length is scanned within a single scan control clock, and a norm-trajectory-segment with three times the norm-length is scanned within three scan control clocks.

It is not necessary that the entire normalized intended trajectory consists of norm-trajectory-segments, nor necessarily the majority thereof. For example, in the region of sharp curves or corners or in order to compensate remaining lengths, it may be advantageous to select other (shorter) trajectory-segments. On the other hand, an intended trajectory that happens to include a number of norm-trajectory-segments cannot be designated as a normalized intended trajectory since these have not been deliberately inserted there. For a normalized intended trajectory, it is specifically necessary that norm-trajectory-segments have been specifically set. This can be seen, for example, from the fact that there is a sequence of two, three or more norm-trajectory-segments or that at least after a sharp curve or corner of the intended trajectory a number of norm-trajectory-segments follow directly.

Preferably, a normalized intended trajectory contains more than 10% norm-trajectory-segments, preferably more than 30% or 50%, in particular more than 70% or 80%, or preferably at least a quarter or in particular more than half. Particularly preferably, in a normalized intended trajectory, two, three or more norm-trajectory-segments follow one another, in which case these do not necessarily all have to be the same length, but can have integer multiples of the norm-length.

The generation of irradiation control data is known in the prior art and is regularly carried out when converting component datasets into control commands in such a way that a device for additive manufacturing can produce a component layer with a solidification of building material using these irradiation control data. The special feature, however, is that not (only) conventional intended trajectories are included in the irradiation control data, but (also) normalized intended trajectories. Only normalized intended trajectories can be included in the irradiation control data, as well as normalized intended trajectories and (conventional) target trajectories together. However, at least one normalized intended trajectory must always be included in the irradiation control data, preferably a plurality of these normalized intended trajectories.

The output of the irradiation control data is known in the prior art. These can initially be output to a memory unit (and stored there) for later use and/or transferred (directly) to a device for the additive manufacturing of a component.

As already indicated, in a manufacturing process in a construction field, building material is applied in layers, i.e. one after the other in several material application planes or material layers. The building material is preferably a metal powder or at least a metal-based powder.

Such a powder preferably contains more than 50% metal, in particular more than 60%, 70%, 80% or even more than 90% metal. However, the invention is not restricted to this but can also be used with other, preferably powdered, building materials, such as plastics or ceramics or mixtures of different materials. In this case, in particular between the application of two material layers, building material is solidified (in particular selectively) by irradiating the building material with at least one energy beam generated by an irradiation unit of the manufacturing device (this means an energetic beam of photons or particles, e.g. a light beam or an electron beam). In this case, not only is the building material in the uppermost, recently applied material layer captured and melted or remelted by the energy beam, but the energy beam usually goes a little deeper into the material bed and also reaches the underlying, already remelted material from previously applied material layers.

The previously described method can be used to generate irradiation control data according to the invention which can be used to control a device for additive manufacturing. As mentioned above, these irradiation control data are characterized by the fact that they comprise normalized intended trajectories or are at least partially based on them. The irradiation control data preferably also comprise further design instructions such as layer application of building material and in particular the lowering of the building platform between the manufacture of the component layers. This is implicitly the case with an arrangement of two component layers, since a new component layer can only be applied to an already solidified region by applying new building material. As a result of this application, it is usually necessary to lower the building platform.

It should be noted that the invention can be applied for a complete component layer. However, its particular advantages lie where (continuous) non-rectilinear trajectories are present. This is particularly the case in the region of (external or internal) contours of a component layer, in the region of onion-shaped trajectories or spiral-shaped trajectories. Especially in the case of long, non-straight intended trajectories, the invention has the advantage of a very homogeneous energy input during manufacture.

In a manufacturing method according to the invention for the additive manufacturing of a component, the component is constructed in layers in a construction field in the form of component layers by selective solidification of building material, preferably comprising a metal-based powder, by irradiating the building material with at least one energy beam according to the control data according to the invention. To create component layers of the component, the energy beam is guided at least partially along normalized intended trajectories according to the irradiation control data. Since these normalized intended trajectories comprise norm-trajectory-segments, there is a correct energy input at least there during manufacture.

A control data generation device according to the invention serves for generating irradiation control data according to the invention (according to the method according to the invention) for a device for the additive manufacturing of a component in a manufacturing process in which the component is built up in a construction field in the form of component layers by selective solidification of building material, preferably comprising a metal-based powder, by irradiating the building material with at least one energy beam.

The control data generation device comprises the following components:
a data interface designed to receive a component dataset comprising geometry data of at least one component layer of the component and/or comprising a trajectory dataset with scan trajectory-segments for producing a component layer of the component,
a normalization unit designed for generating a number of normalized intended trajectories from the component dataset, wherein a normalized intended trajectory is formed from norm-trajectory-segments whose spatial length is an integer multiple of a norm-length determined from a pre-defined scan control clock of the device,
a control data generation unit designed for generating irradiation control data such that the device for additive manufacturing can create a component layer with a solidification of building material along the number of normalized intended trajectories,
a data interface designed for outputting the irradiation control data to a memory unit and/or to a device for the additive manufacturing of a component.

A control device according to the invention serves as a device for the additive manufacturing of a component in a manufacturing process in which the component is constructed in layers in a construction field in the form of component layers by selective solidification of building material, preferably comprising a metal-based powder, by irradiating the building material with at least one energy beam by means of an irradiation device. The control device is designed to control the device for additive manufacturing of the component layers of the component according to irradiation control data according to the invention. Preferably, the control device according to the invention comprises a control data generation device according to the invention.

A device according to the invention (“manufacturing device”) is used for the additive manufacturing of at least one component in an additive manufacturing process. It comprises at least
a feeding device for applying material layers of building material on a construction field in a process room,
an irradiation device for selective solidification of building material by irradiation with at least one energy beam, in particular between the application of two material layers, and
a control device according to the invention.

It should be noted at this point that the device according to the invention can also have several irradiation devices, which are then controlled accordingly in a coordinated manner using the control data, as mentioned above. It should also be mentioned again that in this respect the energy beam can also consist of several superimposed energy beams or that the energy beam can comprise both particle radiation and electromagnetic radiation, such as light or preferably laser radiation.

The invention can be implemented in particular in the form of a computer unit, in particular in a control device, with suitable software. This means in particular the creation of control data, since the manufacture of a component takes place using further components. The computer unit can, for example, have one or more cooperating microprocessors or the like for this purpose. In particular, it can be implemented in the form of suitable software program parts in the computer unit. A largely software-based implementation has the advantage that previously used computer units, in particular in control devices of manufacturing equipment, can also be easily retrofitted by a software or firmware update to work in the manner according to the invention. In this respect, the object is also achieved by a corresponding computer program product with a computer program which can be loaded directly into a memory device of a computer unit, with program sections in order to carry out all the steps of the method according to the invention (at least those which relate to the generation of control data, but possibly also those which serve to transmit the control data for a production process) when the program is executed in the computer unit. Such a computer program product may, in addition to the computer program, comprise additional components such as documentation and/or additional components, including hardware components, such as hardware keys (dongles, etc.) for using the software. A computer-readable medium, such as a memory stick, a hard disk or another portable or permanently installed data support, on which the program sections of the computer program that can be read and executed by a computer unit are stored, can be used for transport to the computer unit and/or for storage on or in the computer unit.

Further, particularly advantageous embodiments and further developments of the invention are obtained from the dependent claims and the following description, wherein the independent claims of one claim category can also be further developed analogously to the dependent claims and exemplary embodiments of another claim category and in particular also individual features of different embodiments or variants can be combined to form to new exemplary embodiments or variants.

In a preferred method, the norm-length is determined by calculating a path that can be covered within the time duration of an interval of a scan control clock at a pre-defined target scanning speed. Preferably, the step of determining the norm-length is carried out in a step preceding the manufacturing process. For example, it can be carried out as part of the development of process parameter value sets for specific materials and/or reference component geometries. In this case, it is preferred that the norm-length N is the distance that can be covered during the duration of an interval of the scan control clock T (a frequency in Hz) at a pre-defined scanning speed v of an energy beam, with N=v/T. The pre-defined (target) scanning speed can be a speed averaged from a speed curve to which an energy beam is to be accelerated or according to which an energy beam is actually accelerated if a certain distance and a duration for covering this distance are specified for a certain scanner (energy beam deflection device).

It is preferred that the target scanning speed is specified as a function of a desired energy input and/or a desired pulse frequency of the energy beam and/or a geometry of the component and/or a quality criterion and/or a user specification.

It should be noted that the target scanning speed can vary within an intended trajectory or between two regions of the component layer. In the case of an intended trajectory, e.g. in the form of a polygon, norm-trajectory-segments with different target scanning speeds can be determined. However, it is always the case that a norm-length is derived from a target scanning speed, so that within a region of an intended trajectory that is to be travelled with the same target scanning speed, the same norm-length applies.

An improvement of the method, especially for the manufacture of geometrically complex components with a comparatively high scanning speed, can also be achieved by selecting the target speed based on a measure of a geometric complexity. A measure for the complexity of a region of the component layer can be, for example, a value corresponding to a fractal dimension, in which case however a minimum value for the scaling greater than zero is assumed. In addition, a deviance can be specified by a user or a preset that indicates how large manufacturing tolerances can be. Since the norm-length depends preferentially on the target scanning speed, a normalized intended trajectory can be designed in such a way that a shorter norm-length (lower target speed) is used in regions of high geometric complexity than in regular regions. By specifying the deviance, however, the target speed can be selected to be overall higher, since e.g. fine details of the component can also be worked out by post-processing. It is therefore particularly preferred to specify a maximum geometric deviation of the manufacturing accuracy at least for regions of a component and/or a component layer and to select a maximum possible target scanning speed within the scope of this deviance.

As far as performance is concerned, it is preferred within the scope of the invention that irradiation of the component layer that is as homogeneous as possible is achieved. For this purpose, the frequency of the energy beam and/or the absorption capacity of the building material as well as the target scanning speed or the angle of incidence or the intensity distribution of the energy beam can also be taken into account. The term “intensity distribution” covers the geometric shape or extension of the energy beam in a plane of intersection (cross-sectional area) perpendicular to the beam direction or beam axis and also the spatial distribution of the intensity over the cross-sectional area, i.e. in particular the positions of maxima and minima.

With regard to the quality criterion, it should be noted that different materials can produce components of different quality when subjected to the same irradiation. Here, the desired strength of the component or the accuracy of dimensions constitutes a preferred quality criterion.

As far as a user preference is concerned, all of the aforesaid parameters may not necessarily be given by pre-settings, but by user specifications. Preferably, however, the user specification comprises a specification as to which of the aforesaid parameters should be taken into account when calculating the norm-length.

In a preferred method, the component dataset comprises a trajectory dataset which (in turn) comprises a number of original target trajectories, wherein an original target trajectory (precisely one or at least one) is formed from scan trajectory segments, and the normalized intended trajectory is created by modifying the original target trajectory by replacing a plurality of its scan trajectory segments by norm-trajectory-segments. Therefore, intended trajectories (with non-normalized trajectory-segments) already exist and the trajectory-segments of these intended trajectories are replaced by norm-trajectory-segments during the modification. Trajectory-deviations may occur, but these are tolerated. However, that norm-trajectory-segment (with an integer multiple of the norm-length) which leads to the smallest deviation from the original intended trajectory at the respective point should always be used. For example, if an intended trajectory with curves is provided and the modification is started at the beginning of the original intended trajectory, the scan trajectory-segments of the original intended trajectory are replaced by a chain of norm-trajectory-segments. If the first curve of the original intended trajectory is now reached, the method looks at which norm-trajectory-segment (with an integer multiple of the norm-length) would lead to the smallest deviation from the original intended trajectory and this norm-trajectory-segment is used. The next norm-trajectory-segment is then preferably selected and oriented in such a way that the smallest deviation from the original intended trajectory is achieved. In particular, long straight sections of the original intended trajectory can be approximated with a wave pattern of norm-trajectory-segments if the length of this straight section does not correspond to an integer multiple of the norm-length.

It is preferred to examine whether scan trajectory-segments are present in the original intended trajectory whose length exceeds a pre-defined limiting value (e.g. the norm-length or an integer multiple of the norm-length). These scan trajectory-segments are then replaced by norm-trajectory-segments. Alternatively or additionally, starting from a pre-determined point on the original target trajectory (e.g. from the beginning or from a curve or corner) scan trajectory-segments of the original intended trajectory, in particular a chain of scan trajectory-segments, are replaced by a chain of norm-trajectory-segments.

In general, it is preferred that norm-trajectory-segments are present at least at the beginning of the normalized intended trajectory and/or after corners or curves. Chains of several norm-trajectory-segments are particularly preferred.

In a preferred method, the component dataset comprises geometry data of at least one component layer of the component. A number of normalized intended trajectories are then determined from the geometry data so that the component layer can be constructed at least partially from norm-trajectory-segments. This constitutes an alternative to the aforesaid modification of an original intended trajectory, in which (normalized) intended trajectories are determined directly from the geometry data of the component. The general procedure is basically known in the prior art and is used to generate the aforesaid original intended trajectories. However, the special feature in the sense of the invention is that no longer (only) arbitrary trajectory-segments may be used, but at least some of the trajectory-segments must be norm-trajectory-segments.

The case can also arise that the component dataset partially contains (original) intended trajectories. These can then be modified and normalized intended trajectories can be created directly in the other regions. The previous alternatives can therefore both be applied in different regions of a component layer.

In a preferred method, an intended trajectory is determined by trajectory points. The trajectory-segments (norm- and scan-trajectory-segments) then preferably correspond to straight-line paths between successive trajectory points, but could also correspond to curvilinear trajectory-segments such as, for example, circular arc segments or splines. As part of a modification of an original intended trajectory (previously explained), this is approximated by a normalized intended trajectory (comprising norm-trajectory-segments). Alternatively or additionally (in other regions of the component layer), when creating a normalized intended trajectory from geometry data, a structure of the component layer in question is at least partially approximated from norm-trajectory-segments.

It is preferred that an intended trajectory (the original and/or the normalized one) is a polygon. This intended trajectory was produced in particular by triangulating a computer-generated geometry of the component and subsequent slicing.

The general generation of target trajectories is known in the prior art. In this case, the surface of a component is represented by one or more surface segments (patches) that are mathematically described. In the simplest case, a surface segment can be a triangle or polygon, but it can also be a freeform surface or implicit surface (a mathematical surface in Euclidean space described by an equation of the form F(x,y,z)=0). For the surface segments, the intersection curves with the exposure plane are determined. If this is difficult or not possible analytically, an approximation (e.g. as a polygonal chain) of these intersection curves can also be determined. What is not known in the prior art is that this approximation is carried out using norm-trajectory-segments. If the component surface encloses a volume (which does not always have to be the case), then the intersection curves of a composite closed component surface are sorted in their order and linked together so that a closed curve is created, i.e. intersection curves from neighbouring surface segments are linked together again. To take the width of a melt track into account, the intended trajectory in the exposure plane can be offset in the direction of the normal of the intended trajectory (which is perpendicular to the intended trajectory in the exposure plane) as part of a “beam offset”. This step can be performed with the intersection curves before the approximation, with the result that the norm-length can to be taken into account in the approximation. Alternatively, this step can be carried out with the already approximated trajectory-segments, in which case the normalization is only carried out after the offset has been calculated, since the length of the trajectory-segments is changed by the offset.

Naturally, additional steps can be taken. When an original intended trajectory is modified, this is present in such a way that it can be scanned by the energy beam to produce the component. When working with geometry data, finished slices could be loaded or the normalized intended trajectories can be generated directly from CAD data. The trajectory is then frequently “offset” since due to the width of the energy beam, for example, this should not run directly along an edge.

In a preferred method, a number of trajectory points of an original intended trajectory or a number of points in geometry data is pre-defined as a corresponding number of trajectory-fixed-points. These trajectory-fixed-points are points at which the normalized intended trajectory should run. There should therefore be no deviation from the original intended trajectory or the normalized intended trajectory should at least lie at one trajectory-fixed-point on the original intended trajectory. In this case, the norm-trajectory-segments are arranged in the normalized intended trajectory in such a way that they touch the number of trajectory-fixed-points and in particular originate and/or end there.

In a preferred method, there is an included angle present in a trajectory-section of an intended trajectory which is less than a pre-determined limiting angle or there is a curve whose curve radius is less than a certain limiting radius. In this case, it is preferred that the course of the normalized intended trajectory is formed with scan trajectory-segments whose length differs from an integer multiple of the norm-length and is in particular shorter than the norm-length. No norm-trajectory-segments are used there.

In a preferred method, the course of a normalized intended trajectory is determined dependent from a pre-defined track-width of a solidification track solidified along this normalized intended trajectory during manufacture of the respective component layer. The track-width of a solidification track that would be formed on such an intended trajectory is therefore determined in advance. For this purpose, all that is needed is expert knowledge (or an experiment) of what a solidification track would look like that would be formed with the specified target scanning speed and beam intensity (possibly also pulse mode). With this knowledge, it can then be determined very easily which position the (normalized) intended trajectories should have. The distance between two adjacent normalized intended trajectories is preferably substantially smaller than the track-width and the distance between a normalized intended trajectory and the edge of the component layer is preferably smaller than or equal to half the track-width. The term “substantially” means that it should apply to at least 60% of the respective trajectory, in particular to at least 80%.

It is preferred that, when modifying an original intended trajectory (see above), if this runs along the edge of the component layer, norm-trajectory-segments, which replace scan trajectory-segments of this original intended trajectory, run between the original intended trajectory and the edge or on the original intended trajectory. There should therefore be no material missing at the edge, but at most there should be too much material there, since a subsequent removal of material is easier than a subsequent addition of material.

In a preferred method, in addition to the component dataset, further irradiation control data are provided, which include data on which regions of the trajectory-segments the energy beam of the device is switched on and switched off or is used in a pulsed manner and/or what power the energy beam should have. In the case of a preferred modification of scan trajectory-segments, the other irradiation control data are then preferably additionally (appropriately) modified. This means in particular that the passages where the energy beam is switched on are adapted to the corresponding norm-trajectory-segments.

This embodiment allows an optimization of the manufacture of the component, since, in particular, if the desired power of the energy beam is known, it is also known which regions of the component layer are to be irradiated as homogeneously as possible. Although the method according to the invention basically ensures homogeneous irradiation through the use of norm-trajectory-segments, it can occur however that the norm-length of norm-trajectory-segments changes, e.g. in regions where a different target scanning speed is applied for manufacturing reasons. In particular, it should be noted that there may be known changes in the target scanning speed depending on the manufacturing device, such as for example, slowing down before sharp curves or corners to compensate for the scanner drag.

In the following, an advantageous addition to the method according to the invention is described, which enables particularly homogeneous manufacture.

According to a preferred method, the power of the energy beam is controlled depending on the respective length of trajectory-segments, so that the power of the energy beam is greater for longer trajectory-segments than for shorter trajectory-segments. Since the longer trajectory-segments are frequently scanned at a higher actually applied manufacturing scanning speed than the shorter ones and thus different amounts of energy per region would be introduced per unit of time at an identical power, this step allows a more homogeneous energy input onto the component surface. The precise manner of controlling the power can be determined by calculations or by testing. Preferably, the power of the energy beam is controlled in such a way that the same amount of energy is introduced into the building material on all relevant trajectory-segments during manufacture. Naturally, different regions with a different desired energy input can be selected in a component layer.

The preceding considerations then apply within such a region.

The invention is explained in more detail below with reference to the attached figures using embodiments. In the different figures, identical components are provided with identical reference numbers. In the figures:

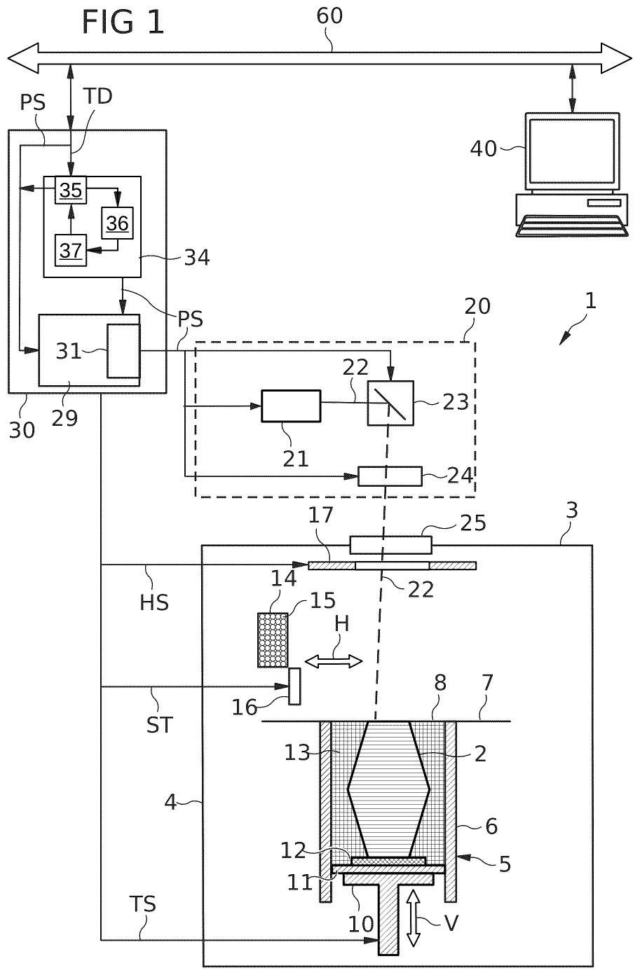

FIG. 1 shows a schematic view, depicted partially in section, of an exemplary embodiment of a device for additive manufacturing,

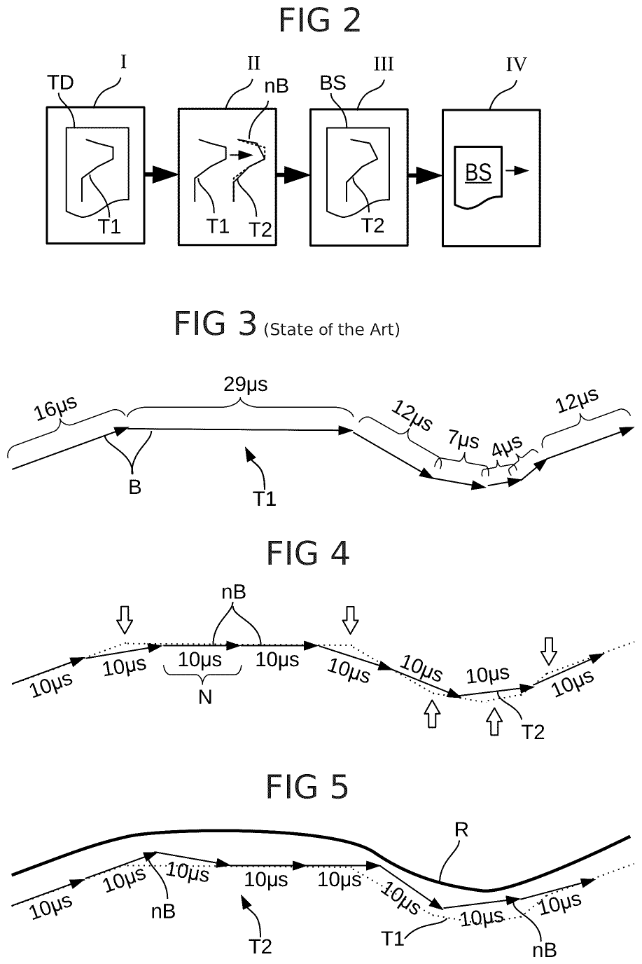

FIG. 2 shows a block diagram of a possible process sequence of an exemplary embodiment of a method according to the invention,

FIG. 3 shows an example of an original intended trajectory according to the prior art,

FIG. 4 shows an example of a normalized intended trajectory generated by the method according to the invention,

FIG. 5 shows an example of a normalized intended trajectory at the edge of a component layer,

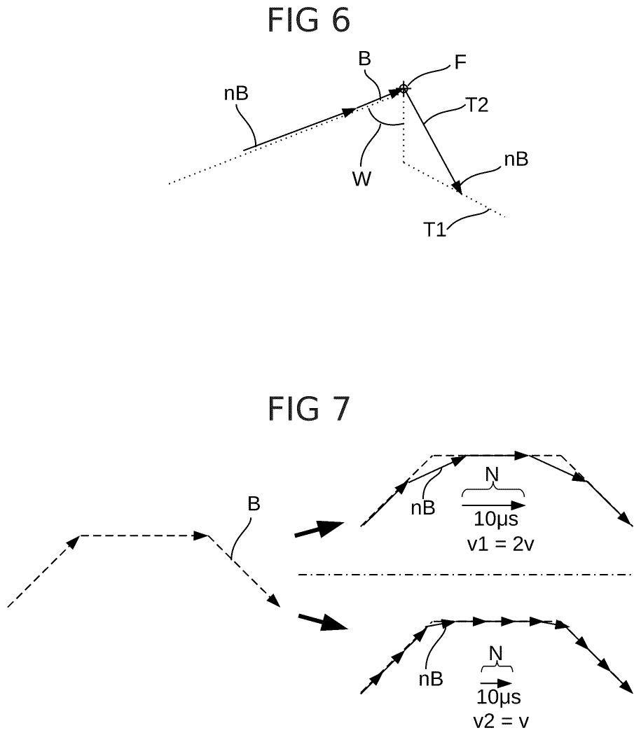

FIG. 6 shows an example of a normalized intended trajectory with a fixed trajectory point,

FIG. 7 shows examples of normalized intended trajectories created by modifying an original intended trajectory.

The following exemplary embodiments are described with reference to a device 1 for the additive manufacturing of components in the form of a selective laser sintering or laser melting device, wherein it is explicitly pointed out again that the invention is not limited to selective laser sintering or laser melting devices. The device is therefore referred to hereinafter—without any restriction of the generality—as “manufacturing device” 1 for short.

Such a manufacturing device 1 is shown schematically in FIG. 1. The device has a process chamber 3 or a process space 3 with a chamber wall 4, in which the manufacturing process substantially takes place. Located in the process chamber 3 is a container 5 which is open at the top and has a container wall 6. The upper opening of the container 5 forms the respectively current working plane 7. The region of this working plane 7 located within the opening of the container 5 can be used to construct the object 2 and is therefore referred to as the construction field 8.

The container 5 has a base plate 11 which is movable in a vertical direction V which is arranged on a carrier 10. This base plate 11 terminates the container 5 downwards and thus forms its base. The base plate 11 can be formed integrally with the carrier 10, but it can also be a plate formed separately from the carrier 10 and fastened to the carrier 10 or simply mounted thereon. Depending on the type of specific building material, for example the powder used, and the manufacturing process, a building platform 12 can be attached to the base plate 11 as a building substrate on which the object 2 is constructed. In principle however, the object 2 can also be constructed on the base plate 11 itself, which then forms the building substrate.

The fundamental construction of the object 2 is accomplished by applying a layer of building material 13 initially to the building platform 12, then—as is explained subsequently—the building material 13 is selectively solidified using a laser beam 22 as an energy beam at the points which are to form parts of the object 2 to be manufactured, then with the aid of the carrier 10 the base plate 11, therefore the building platform 12, is lowered and a new layer of the building material 13 is applied and selectively solidified, etc. In FIG. 1, the object 2 constructed in the container on the building platform 12 is shown below the working plane 7 in an intermediate state. Said object already has a plurality of solidified layers, surrounded by building material 13 that has remained unsolidified. Various materials can be used as the building material 13, preferably powder, in particular metal powder, plastic powder, ceramic powder, sand, filled or mixed powders or also pasty materials and optionally a mixture of several materials.

Fresh building material 15 is located in a storage container 14 of the manufacturing device 1. With the aid of a layering device 16 which can be moved in a horizontal direction H, the building material can be applied in the form of a thin layer in the working plane 7 or within the construction field 8.

Optionally, an additional radiation heater 17 is located in the process chamber 3. This can be used to heat the applied building material 13 so that the irradiation device used for the selective solidification does not have to introduce too much energy. This means that, for example, with the aid of the radiation heater 17, a quantity of basic energy can be introduced into the building material 13, which is naturally still below the energy required for the building material 13 to fuse or sinter. An infrared radiator or VCSEL radiator, for example, can be used as radiation heater 17.

For selective solidification, the manufacturing device 1 has an irradiation device 20 or, more specifically, an exposure device 20 with a laser 21. This laser 21 generates a laser beam 22, which is deflected by a deflection device 23 in order to trace the exposure paths or traces (hatch lines/scan vectors) provided according to the exposure strategy in the layer to be selectively solidified and to selectively introduce the energy. Furthermore, this laser beam 22 is focused in a suitable manner onto the working plane 7 by a focusing device 24. The irradiation device 20 is preferably located outside the process chamber 3 and the laser beam 22 is guided into the process chamber 3 via a coupling window 25 attached to the top of the process chamber 3 in the chamber wall 4.

The irradiation device 20 can, for example, comprise not only one but several lasers. Preferably, these can be gas or solid-state lasers or any other type of laser such as laser diodes, in particular VCSEL (Vertical Cavity Surface Emitting Laser) or VECSEL (Vertical External Cavity Surface Emitting Laser) or a row of these lasers. Quite particularly preferably, within the scope of the invention, one or more unpolarized single-mode lasers, e.g. a 3 KW fibre laser with a wavelength of 1070 nm can be used.

A control device 30 comprising a control unit 29 is used to control the units of the manufacturing device 1, which controls the components of the irradiation device 20, namely here the laser 21, the deflection device 23 and the focusing device 24, and for this purpose accordingly transfers process control data PS to them.

The control unit 29 also controls the radiation heater 17 by means of suitable heating control data HS, the coater 16 by means of coating control data ST and the movement of the carrier by means of carrier control data TS and thus controls the layer thickness.

The control device 30 is, here, for example, via a bus 60 or another data connection, coupled to a terminal 40 with a display or the like. Via this terminal 40, an operator can control the control unit 30 and thus the entire laser sintering device 1, e.g. by transmitting process control data PS.

In order to optimize the production process, the control data PS are generated or modified in the manner according to the invention by means of a control data generation device 34 such that the control of the device 1 takes place at least temporarily in a mode according to the invention.

The control data generation device 34 here comprises a data interface 35 designed to receive a component dataset TD. This component dataset TD here comprises geometry data of the component layers of the component 2 or a trajectory dataset TD, as shown in the following figures, with scan trajectory-segments B for producing a component layer of the component 2.

In addition to the data interface 35, the control data generation device 34 comprises a normalization unit 36, designed to generate a number of normalized intended trajectories T2 from the component dataset TD, e.g. by modifying trajectory datasets TD as shown in the following figures. In this case, a normalized intended trajectory T2 is formed from norm-trajectory-segments nB, the spatial length of which is an integer multiple of a norm-length N, which in turn is determined from a pre-defined scan control clock of the device 1.

Furthermore, the control data generation device 34 comprises a control data generation unit 37 which is designed to generate irradiation control data BS which are part of the process control data PS.

The aforesaid data interface 35 is additionally designed so that the irradiation control data BS can be output to the device 1 for the additive manufacturing of a component 2. However, a separate data interface can also be used for this purpose.

It is also possible that the control data generation device 34 is implemented on an external computer unit, for example the terminal 40, and generates in advance process control data PS with correspondingly suitable irradiation control data BS, with which the device 1 is then controlled. This process control data PS, or irradiation control data BS can then be stored in a memory of the computer unit until they are used.

It is also pointed out again at this point that the present invention is not restricted to such a manufacturing device 1. It can be applied to other processes for the generative or additive production of a three-dimensional object by layer-by-layer application and selective solidification of a building material, whereby an energy beam is emitted for solidification onto the building material to be solidified. Accordingly, the irradiation device can not only be a laser, as described here, but any device could be used with which energy can be selectively brought onto or into the building material as wave or particle radiation. For example, instead of a laser, another light source, an electron beam, etc. could be used.

Even if in FIG. 1 only a single object 2 or component 2 is shown, it is possible and usually also usual to produce several objects in parallel in the process chamber 3 or in the container 5. For this purpose, the building material is scanned layer by layer by the energy beam 22 at locations that correspond to the cross-sections of the objects in the respective layer.

FIG. 2 shows a block diagram of a possible process sequence of an exemplary embodiment of a method according to the invention for generating irradiation control data BS for a device 1 for the additive manufacturing of a component 2 in a manufacturing process in which the component 2 is constructed in layers in a construction field 8 by selective solidification of building material 13 by means of irradiation of the building material 13 with at least one energy beam 22.

In step I, a component dataset TD is provided which comprises geometry data of at least one component layer of the component 2 and/or comprising a trajectory dataset TD with scan trajectory-segments B for manufacturing a component layer of the component 2. This is symbolized here with a trajectory dataset TD with an original target trajectory T1.

In step II, normalized intended trajectories T2 are generated from the component dataset TD, here by modifying original intended trajectories T1. A normalized intended trajectory T2 is formed from norm-trajectory-segments nB whose spatial length is an integer multiple of a norm-length N, which is determined from a pre-defined scan control clock of the device 1.

The norm-length N can, for example, be specified so that firstly a target scanning speed v1, v2 (see e.g. FIG. 7) is determined, e.g. depending on a process window for processing a specific building material and/or a maximum scanner dynamic and/or a productivity criterion and/or a manufacturing quality criterion, and the distance is calculated that would be covered by an energy beam which was guided at this scanning speed v1, v2 over a construction field 8 over the duration of a scan control clock pulse (or an integer multiple of scan control clock pulses).

In step III, irradiation control data BS are generated and specifically in such a way that a manufacturing device 1, as shown in FIG. 1 for example, with these irradiation control data BS, can generate component layers with a solidification of building material 13 along the number of normalized intended trajectories T2. Now for example, it can be examined whether there are scan trajectory-segments B in the original intended trajectory T1 whose length is less than the norm-length or an integer multiple of this norm-length. These scan trajectory-segments B are then replaced by norm-trajectory-segments nB. However, it is better if, starting from a pre-determined point of the original intended trajectory T1, a chain of scan trajectory-segments B of the original intended trajectory T1 is replaced by a chain of norm-trajectory-segments nB, as shown in the following figures.

In step IV, these irradiation control data BS are then output to a memory unit and/or to a manufacturing device 1.

FIG. 3 shows an example of an original intended trajectory T1 according to the prior art, which is determined by trajectory points and whose scan trajectory-segments B correspond to rectilinear paths between successive trajectory points. Scanning these scan trajectory-segments B, which have different lengths, takes an individual time for each scan trajectory-segment B, which is displayed here.

FIG. 4 shows an example of a normalized intended trajectory T2, which was formed as part of a modification of the original intended trajectory T1 from FIG. 3, which is still indicated here with dotted lines. This normalized intended trajectory T2 has norm-trajectory-segments nB, all of which have a norm-length N and whose scanning requires a fixed time that is specified by the scan control clock. As can be seen, the normalized intended trajectory T2 only approximates the original intended trajectory T1 and does not lie precisely on the original intended trajectory T1 at all points (arrows).

FIG. 5 shows an example of a normalized intended trajectory T2 at the edge R of a component layer. In contrast to FIG. 4, in which norm-trajectory-segments nB are located above and below the original intended trajectory T1, norm-trajectory-segments nB are now always arranged towards the edge if the normalized intended trajectory T1 deviates from the original intended trajectory T1. The reason for this is that although the edge of the component can be easily reworked by removing material, an addition of material is more difficult however.

FIG. 6 shows an example of a normalized intended trajectory T2 with a fixed trajectory point F. This fixed trajectory point F has already been defined on the original intended trajectory T1 and represents a point at which a trajectory-segment B, nB should end. In the case of the normalized intended trajectory T2, no norm-trajectory-segment nB is used, but rather a shorter scan trajectory-segment B to reach this fixed trajectory point at F. Then, from this fixed trajectory point F, the trajectory continues with norm-trajectory-segments nB.

FIG. 7 shows examples of normalized intended trajectories T2 that were created by modifying an original target trajectory T1. Top right and bottom right show two possibilities for normalized intended trajectories T2, which can result at different scanning speeds v1, v2. At the top, the scanning speed v1 is higher and at the bottom, the scanning speed v2 is lower, which leads to larger norm-lengths N at the top. According to the different norm-lengths N, the course of the original intended trajectory T1 is also approximated differently.

Finally, it is pointed out once again that the devices described in detail hereinbefore are merely exemplary embodiments which can be modified in various ways by a person skilled in the art without departing from the scope of the invention. For example, a solidification could be achieved using other energy beams instead of laser light. Furthermore, the use of the indefinite articles “a” or “an” does not exclude the possibility that the characteristics in question may also be present more than once. Likewise, the term “unit” does not exclude the possibility that it consists of several interacting subcomponents, which may also be spatially distributed. The expression “a number” should also be understood to mean “at least one”.

### REFERENCE LIST

1 Device for additive manufacturing/laser sintering device
2 Component/object
3 Process room/process chamber
4 Chamber wall
5 Container
6 Container wall
7 Working plane
8 Construction field
10 Support
11 Base plate
12 Building platform
13 Building material (in container 5)
14 Storage container
15 Building material (in storage container 14)
16 Layering device
17 Radiation heater
20 Irradiation device/exposure device
21 Laser
22 Laser beam/energy beam
23 Deflecting device/scanner
24 Focusing device
25 Coupling-in window
29 Control unit
30 Control device
31 Irradiation control interface
34 Control data generation device
35 Data interface
36 Normalizing unit
37 Control data generation unit
40 Terminal
60 Bus
B Scan trajectory-segment
nB Norm-trajectory-segment
BS Irradiation control data
F Trajectory-fixed-point
H Horizontal direction
HS Heating control data
N Norm-length
PS Process control data/control data
R Edge
SB Process room sensor dataset
ST Layer control data
T1 Original intended trajectory
T2 Normalized intended trajectory
TD Trajectory dataset/component dataset
TS Support control data
V Vertical direction
v1, v2 Target parameter/scanning speed

1. A method for generating irradiation control data for a device for additive manufacturing of a component in a manufacturing process in which the component is constructed in layers in a construction field by selective solidification of building material by irradiation of the building material with at least one energy beam, the method comprising the steps:
providing a component dataset comprising geometry data of at least one component layer of the component and/or comprising a trajectory dataset with scan trajectory-segments for producing a component layer of the component;
creating a number of normalized intended trajectories from the component dataset, wherein a normalized intended trajectory is formed from norm-trajectory-segments whose spatial length is an integer multiple of a norm-length which is determined from a pre-defined scan control clock of the device;
generating irradiation control data such that the device for additive manufacturing can create a component layer with a solidification of building material along the number of normalized intended trajectories; and
outputting the irradiation control data to a memory unit and/or to a device for the additive manufacturing of a component.

2. The method according to claim 1, wherein the norm-length is determined by calculating a path that can be covered within the time period of an interval of a scan control clock with a pre-defined target scanning speed, wherein the target scanning speed
is specified as a function of a desired energy input and/or a desired pulse frequency of the energy beam and/or a geometry of the component and/or a quality criterion and/or a user specification, and/or
changes within an intended trajectory or between two regions of the component layer, wherein norm-trajectory-segments of a normalized intended trajectory are determined from different target scanning speeds, and/or
is selected based on a measure of a geometric complexity of the component, wherein a deviance is specified by a user specification or a pre-setting, which indicates how large manufacturing tolerances may be and within this deviance, a maximum possible target scanning speed is selected.

3. The method according to claim 1, wherein the component dataset comprises a trajectory dataset which comprises a number of original intended trajectories, wherein an original intended trajectory is formed from scan trajectory-segments, and the normalized intended trajectory is created by modifying the original intended trajectory by replacing a plurality of its scan trajectory-segments with norm-trajectory-segments, wherein it is examined whether there are scan trajectory-segments in the original intended trajectory whose length is less than a pre-defined limiting value, and wherein the scan trajectory-segments of the original intended trajectory whose length is less than the pre-defined limiting value are replaced by norm-trajectory-segments and/or wherein starting from a pre-defined point of the original intended trajectory, a chain of scan trajectory-segments of the original intended trajectory is replaced by a chain of norm-trajectory-segments.

4. The method according to claim 1, wherein the component dataset comprises geometry data of at least one component layer of the component, and a number of normalized intended trajectories are determined from the geometry data, so that the component layer can be constructed at least partially by means of norm-trajectory-segments.

5. The method according to claim 1, wherein an intended trajectory is determined by trajectory points and the trajectory-segments correspond to rectilinear paths between successive trajectory points, wherein in the context of a modification of an original intended trajectory this is approximated by a normalized intended trajectory, and/or in the context of creating a normalized intended trajectory from geometry data, a structure of the relevant component layer is at least partially approximated from norm-trajectory-segments, wherein an intended trajectory is a polygonal line, and was generated by means of a triangulation of a computer-generated geometry of the component and a subsequent slicing.

6. The method according to claim 5, wherein a number of trajectory points of an original intended trajectory or a number of points in geometry data is pre-defined as a corresponding number of trajectory fixed points at which the normalized intended trajectory should run, and wherein the norm-trajectory-segments are arranged in the normalized intended trajectory in such a way that they touch the number of trajectory-fixed-points.

7. The method according to claim 1, wherein in a trajectory-section of an intended trajectory in which an included angle is present which falls below a pre-defined limiting angle or a curve is present whose curve radius falls below a certain limiting radius, the course of the normalized intended trajectory is formed with scan trajectory-segments whose length differs from an integer multiple of the norm-length wherein at least one trajectory-fixed-point according to claim 6 is present at a corner point or a curve.

8. The method according to claim 1, wherein the course of a normalized intended trajectory is determined as a function of a pre-defined track-width of a solidification track solidified along this normalized intended trajectory during the manufacture of the relevant component layer, wherein the distance between two adjacent normalized intended trajectories is substantially smaller than the track-width and the distance of a normalized intended trajectory to the edge of the component layer is smaller than or equal to half the track-width, preferably wherein when modifying an original intended trajectory, if this runs along the edge of the component layer, norm-trajectory-segments, which replace scan trajectory-segments of this original intended trajectory, run between the original intended trajectory and the edge or on the original intended trajectory.

9. The method according to claim 1, wherein in addition to the component dataset, further irradiation control data are provided, which comprise data on which regions of the trajectory-segments the energy beam of the device is switched on and switched off or is used in a pulsed manner and/or which power the energy beam should have, and wherein
when modifying scan trajectory-segments, the other irradiation control data are additionally modified, and/or
the power of the energy beam is controlled depending on the respective length of trajectory-segments such that the power of the energy beam is greater for longer trajectory-segments than for shorter trajectory-segments.

10. Control data for controlling a device for additive manufacturing, comprising irradiation control data which have been generated according to a method according to claim 1.

11. A manufacturing method for the additive manufacture of a component, wherein in a construction field the component is constructed in layers by selective solidification of building material by irradiating the building material with at least one energy beam according to the control data according to claim 10, wherein to create component layers of the component the energy beam is moved over the construction field within the specified regions according to the control data.

12. The control data generation device for generating irradiation control data according to claim 10, for a device for additive manufacturing of a component in a manufacturing process in which the component is constructed in layers in a construction field by selective solidification of building material by irradiation of the building material with at least one energy beam, the control data generation device comprising:
a data interface designed to receive a component dataset comprising geometry data of at least one component layer of the component and/or comprising a trajectory dataset with scan trajectory-segments for producing a component layer of the component,
a normalization unit designed for creating a number of normalized intended trajectories from the component dataset, wherein a normalized intended trajectory is formed from norm-trajectory-segments whose spatial length is an integer multiple of a norm-length which is determined from a pre-defined scan control clock of the device,
a control data generation unit designed for generating irradiation control data such that the device for additive manufacturing can create a component layer with a solidification of building material along the number of normalized intended trajectories,
a data interface designed for-outputting the irradiation control data to a memory unit and/or to a device for the additive manufacturing of a component.

13. The control device for a device for the additive manufacturing of a component in a manufacturing process in which the component is constructed in layers in a construction field by selective solidification of building material by irradiating the building material with at least one energy beam by means of an irradiation device, wherein the control device is designed to control the device for the additive manufacturing of the component layers of the component according to control data according to claim 10, wherein the control device preferably comprises a control data generation device.

14. A device for the additive manufacturing of at least one component in an additive manufacturing process with at least
a feeding device for applying material layers of building material to a construction field in a process room,
an irradiation device for selective solidification of building material by irradiation with at least one energy beam, between the application of two material layers, and
a control device according to claim 13.

15. A computer program product comprising instructions which, when the program is executed by a computer, cause the computer to carry out the steps of the method according to claim 1.
